(19) United States
(12) Patent Application Publication
(10) Pub. No.: US 2003/0188924 A1
(43) Pub. Date: Oct. 9, 2003

(54) Safety device for ladders

(76) Inventor: Jeffrey V. Bamber, Cincinnati, OH (US)

Correspondence Address: Jeffrey V. Bamber, 5023 Village Drive, Cincinnati, OH, 45244, US

(21) Appl. No.: 10/407,498

(22) Filed: Apr. 4, 2003

Related U.S. Application Data
(60) Provisional application No. 60/370,887, filed on Apr. 6, 2002.

(51) Int. Cl. E06C 7/42

(52) U.S. Cl. 182/107

(57) ABSTRACT

Safety devices for ladders and ladders having such safety devices, and more particularly to a safety device that is capable of temporarily holding the top portion of a ladder securely to a building or other structure are disclosed.

### CROSS-REFERENCE TO RELATED APPLICATIONS

This application claims the benefit of the filing date of U.S. Provisional patent application, Serial No. 60/370,887, filed on Apr. 6, 2002, which is incorporated by reference herein.

### FIELD OF THE INVENTION

This invention relates to safety devices for ladders and ladders having such safety devices, and more particularly to a safety device that is capable of temporarily holding the top portion of a ladder securely to a building or other structure.

### BACKGROUND OF THE INVENTION

Ladders are commonly used for reaching high places. Extension ladders and other types of ladders are often leaned against a wall, such as that of a house, building, or other structure. Such ladders may also be leaned against the overhang or gutters on the roof of a house or building. The person using the ladder will then climb the ladder, and the ladder will be held in place solely by the weight of the ladder and person against the structure. Other types of ladders are known for emergency use in exiting a residence. These may include a hook portion for engaging a window sill and have side rails comprised of rope, or some other flexible material.

Various safety features have been developed for ladders. Some of these are shown in the following U.S. Pat. Nos.: 5,054,581 and 5,121,814.

Despite these safety devices, ladders of the type that are leaned against a structure are typically not anchored to the structure in any manner. This may give the user a feeling that the ladder is not stable or secure. It may also be dangerous in that if person using the ladder shifts their weight excessively to one side, the upper portion of the ladder can move sideways and possibly fall to the side. It is also possible that the ladder may fall backwards. If the ladder falls, the person using the ladder will often fall to the ground. Once the ladder begins to fall in either of these manners, there is little or nothing that can be done to stop the ladder from falling.

Thus, there is a need to provide alternative types of safety devices for ladders and ladders having such safety devices.

### SUMMARY OF THE INVENTION

This invention relates to safety devices for ladders and ladders having such safety devices, and more particularly to a safety device that is capable of temporarily holding the top portion of a ladder securely to a building or other structure.

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention.

In one non-limiting embodiment, the safety device comprises an arm for attaching to an upper portion of a ladder and a holding mechanism. The arm has two end portions comprising a first end portion for attachment to the upper portion of a ladder and a second end portion for holding the ladder to a structure. The holding mechanism may be joined to the second end portion of the arm. The holding mechanism is capable of holding the upper portion of the ladder more securely to the structure than a ladder without the safety device.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is a side view of a house showing two ladders having safety devices thereon, and how the safety devices can be used to temporarily hold the top portion of the ladder securely to the house.

FIG. 2 is a fragmentary perspective view showing the upper portion of a ladder and an embodiment of a safety device therefore which has accordion tubing covering the “arms” of the safety device.

FIG. 3 shows a clip that can be used as a holding mechanism for attaching the safety device to a brick wall.

FIG. 4 shows a ratchet action clamp that can be used as a holding mechanism for attaching the safety device to a portion of a structure.

### DETAILED DESCRIPTION OF THE INVENTION

This invention relates to safety devices for ladders and ladders having such safety devices, and more particularly to a safety device that is capable of temporarily holding the top portion of a ladder securely to a building or other structure.

One non-limiting embodiment of the safety device for a ladder is shown in FIG. 1. Two ladders are shown in FIG. 1. As shown in FIG. 1, the ladders 20 each comprise a pair of rails 22 that support a plurality of spaced apart rungs 24. The safety device is suitable for use with ladders that have rigid rails, as well as those that are flexible and/or collapsible. The ladders 20 have a lower portion 26 and an upper portion 28. The ladders 20 are shown leaning against a structure 30. The lower portion 26 of the ladders 20 typically either directly or indirectly rests on the ground 32. The upper portion 28 of the ladders generally either directly or indirectly rests on the structure 30.

The term “structure”, as used herein, includes walls, such as those of a house, building, or other structure, as well as the overhangs or gutters on the roof of a house or building, and any other article or structure against which it is known to lean a ladder. The right hand side of FIG. 1 shows the ladder 20 leaning against the wall of the structure underneath the overhang and gutter on the roof of the structure 30. The safety device will work equally well if a longer ladder is used in this position, and the ladder is long enough to lean against the gutter. In both cases, the safety device can be attached to the gutters and/or the portion of the roof to which the gutters are attached. The left hand side of FIG. 1 shows the ladder 20 leaning against the side wall of the structure 30 with the safety device attached to a portion of the sloping side of the roof of the structure 30.

In the non-limiting embodiment shown, the safety feature (or “safety device”) 34 comprises an arm 38 for attaching to a ladder and a holding mechanism 40. The arm 38 has two end portions comprising a first end portion 42 preferably for attachment to the upper portion 26 of a ladder 20 and a second end portion 44 for holding the ladder 20 to a structure through the use of the holding mechanism 40. The end portions each comprise one of the ends of the arm 38 (that is, the first and second ends of the arms, respectively). The end portions may also comprise portions of the arm that lie inward of the ends of the arm 38. The holding mechanism 40 may be joined to the second end portion 44 of the arm 38. The holding mechanism 40 is capable of holding the upper portion of the ladder 20 more securely to the structure 30 than a ladder without the safety device 34.

The arm 38 can comprise any suitable type of element capable of joining the holding mechanism 40 to the ladder 20. The arm 38 can be a separate element, or it can be an integral portion of the holding mechanism 40 and/or the ladder 20. In the latter case, the arm 38 and holding mechanism 40 and/or ladder 20 may comprise a single component. The arm 38 can be a permanent part of the ladder 20, or it can be attachable to and/or detachable from the ladder 20. The arm 38 can be joined to any suitable part of the ladder 20 including the rails, the rungs, or both. The arm 38 can be joined to any suitable portion of the ladder 20, and is not limited to being joined to the upper portion of the ladder. The arm 38 can be joined to the ladder 20 by any suitable type of device, including but not limited to clamps, gated rings (e.g., carabiners) and the like. The safety device 34 can comprise a single arm 38, or more than one arm. In the embodiment shown in the drawings, the safety device 34 comprises a pair of arms 38, one adjacent to each rail 22 of the ladder 20.

It may be desirable for the arm 38 to be capable of adapting to a variety of different types of structures and positions relative to such structures. There will often be a different distance between the upper portion 28 of the ladder 20 and the portion of the structure 30 onto which the holding mechanism 40 holds, depending on the structure against which the ladder 20 is placed. In addition, as shown for the ladder 20 on the left side of FIG. 1, each of the arms 38 of the same safety device 34 may be required to extend a different distance in order to attach their respective holding mechanisms 40 to the structure.

Therefore, in some embodiments, it may be desirable for at least portions of the arm 38 to have one or more of the following properties: flexibility; adjustability, extensibility, and/or retractability. The entire arm 38 can have one or more of these properties, or only selected portions thereof can have one or more of these properties. In addition, embodiments are also possible in which the arm 38, or a portion thereof, has one of these properties (for example, flexibility), and another portion of the arm has a different one of these properties (for example, extensibility). Further, it is also possible for different portions of the arm 38 to have differing amounts of any of these properties. For example, one portion of the arm 38 may be flexible, and another portion may be less flexible, or this other portion may be rigid. The arm 38 may have any possible combinations of these properties and permutations. Thus, as shown in FIG. 1, the extensibility of the arms 38 allows them to securely attach the holding mechanisms 40 to portions of the structure that are not at the same level. The arms 38 may be retractable so that they can be tensioned (or made taut) to eliminate any slack in the arms 38. This will prevent the ladder 20 from moving when the safety device 34 is in position.

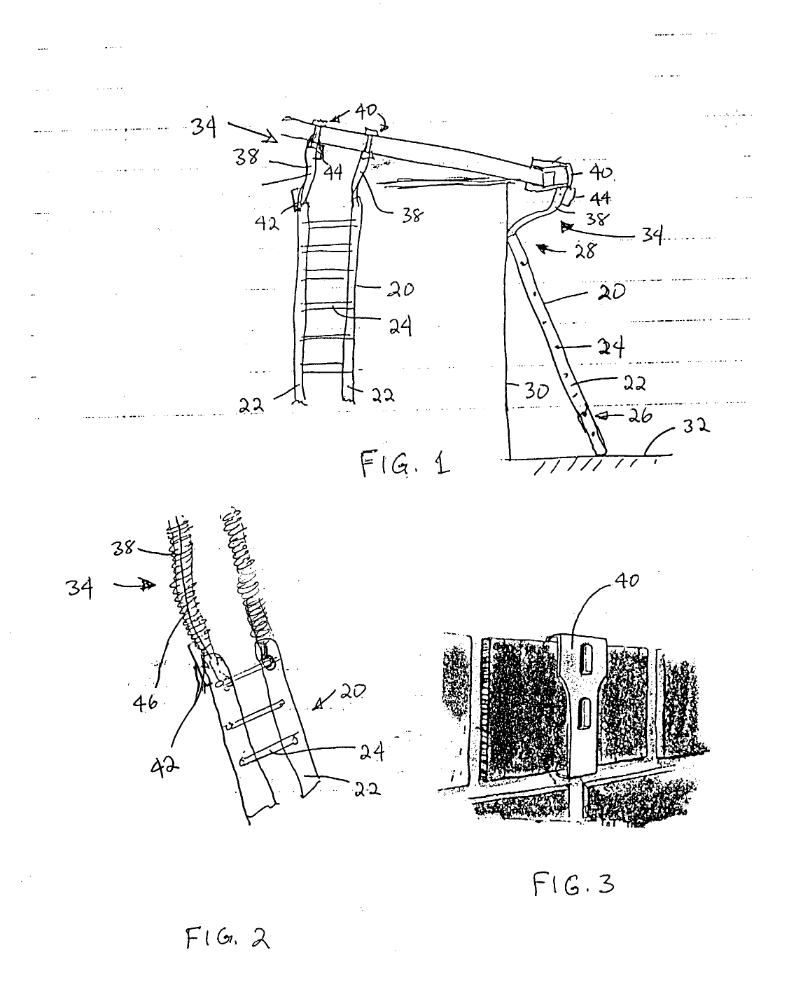

The arm 38 can comprise a non-limiting number of types of articles. It can comprise a single article, or more than one article. Suitable types of articles that can comprise the arm 38 or portions thereof include, but are not limited to: rods, tubes, bars, chains, ropes, straps, cables, wires, belts, and hoses. In addition all or portions of the arm 38 can be comprised of toothed twist tie material or the toothed strap material commonly used to restrain articles and/or persons, or variations thereof such as the material used to adjust the tension on the back of Giro cycling helmets made by Giro Sport Design of Santa Cruz, Calif., U.S.A. Giro patents include U.S. Pat. Nos.: 5,659,900; 5,887,288; 6,009,561; and 6,009,562. Other materials that may be suitable for all or a portion of the arms 38 may be described in U.S. Pat. Nos. 5,159,728 and 5,159,729. Ideally, the arms 38 comprise elements that can be quickly adjusted so that the ladder 20 may be moved conveniently from one location to another. In addition, if desired, the arms 38 may be covered by a material for appearance, safety, or other purposes. One non-limiting type of covering material, accordion tubing 46, is shown in FIG. 2.

The holding mechanism 40 can comprise any suitable type of element that is capable of holding the upper portion of the ladder 20 more securely to the structure 30 than a ladder without the safety device 34. The holding mechanism 40 may operate in any suitable manner. It may be desirable for the holding mechanism to engage the portion of the structure to which it is attached by mechanisms that include, but are not limited to: exerting a force on a portion of the structure (for example, by a clamping action), fastening to a portion of the structure, or interlocking with a portion of the structure. In certain embodiments, it is desirable for the holding mechanism 40 to function by a mechanism other than either solely by friction and/or by the component force of gravity that acts on the ladder when it leans against the structure.

The holding mechanism 40 may be permanently joined to the structure, but preferably is only temporarily joined to the structure 30, or a portion of the structure so that the ladder 20 may be easily moved. The holding mechanism 40 may be capable of holding the ladder 20 securely to the structure 30 so that even if the ladder 20 loses contact with the portion of the structure 30 against which it is leaning, the holding mechanism will remain attached to the structure 30. Alternatively, the holding mechanism may break away from the structure 30 more slowly than the ladder would move from the structure without the holding mechanism 40. In either case, the holding mechanism 40 may provide the person using the ladder with at least some additional time to climb down to safety. In other cases, the holding mechanism may even allow the ladder 20 to be used without having the ladder 20 lean against a portion of the structure.

The holding mechanism 40 can comprise a non-limiting number of types of articles. It may be desirable for the holding mechanism 40 to be adjustable and/or of a “universal” type that is capable of holding to a wide variety of different types of structures or portions thereof, including, but not limited to: window sills, gutters, wood trim, bricks, and roofs. The holding mechanism can operate by any suitable mechanism, including but not limited to by fastening, adhering, clamping, spreading, and inflating. Suitable types of articles that can serve as the holding mechanism 40 can include, but are not limited to: hooks, clamps, including but not limited to spring clamps and vice clamps; fasteners such as nails, or any other known type of fasteners; and expandable elements such as balloons, or mechanical devices that can hold to a portion of the structure (e.g., elements that can be placed in a gutter and inflate or expand within the gutter, or to expand between bricks), and modified versions and/or equivalents of the same. FIG. 3 shows a clip that can be used as a holding mechanism for attaching the safety device to a brick wall. Such a clip was available in the Fall, 1996 Home Trends catalog, Rochester, N.Y., USA, www.hometrendscatalog.com.

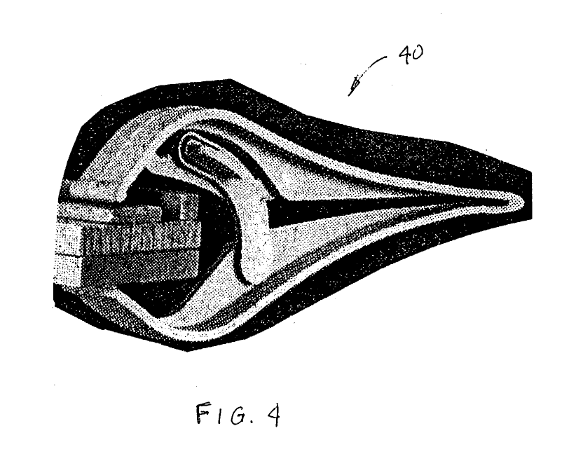

Numerous non-limiting embodiments of the holding mechanism 40 for the safety device 34 are possible. In some embodiments, it may be advantageous for the holding mechanism to be capable of being fastened to the structure by the user with only one hand so that the user can hold onto the ladder with the other hand. For example, FIG. 4 shows a ratchet action clamp that can be used as a holding mechanism 40 for attaching the safety device to a portion of a structure using one hand. Such a ratchet action clamp, as well as other suitable clamps, such as hand clamps that can be used as a holding mechanism for attaching the safety device to a portion of a structure using one hand can be obtained from a variety of sources, including from Micro Mark, Berkeley Heights, N.J., USA, www.micromark.com. Such clamps can be made of different materials or otherwise modified to improve their strength or suitability for use as a holding mechanism. The self-adjusting and/or self-locking pliers described in U.S. Pat. No. 6,178,855 can also be used as a holding mechanism

In other embodiments, a system may be provided comprising the safety device 34 described herein with a variety of different holding mechanisms for securing a ladder to various different types of structures, or portions thereof. In still other embodiments, the arm 38 of the safety device can be provided with an adapter or other component that is configured to engage several different types of interchangeable holding mechanisms. For example, in one non-limiting embodiment, the second end portion 44 of the arm 38 can have a mountain climbing carabiner fastener thereon that mates with a ring located on the end of the handle, or on some other suitable portion, of various different types of holding mechanisms. In other embodiments, a portion of the arm 38, such as the second end portion 44, can be provided with two or more different types of holding mechanisms thereon for joining the ladder to different types of structures. In this latter embodiment, the different types of holding mechanisms can be located along different portions of the length of the second end portion 44. Alternatively, the second end portion 44 may be split into branches, or have an attachment comprising a plurality of branches, and the different types of holding mechanisms can be located on each of the branches. In any of these embodiments, the different types of holding mechanisms 40 can comprise be any combination of the types of holding mechanisms described above.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined solely by the appended claims which should be construed as broadly as the prior art will permit.

What is claimed is:

1. A safety device for a ladder which ladder has an upper portion, said safety device comprising:
an arm for attaching to an upper portion of a ladder, said arm having two end portions comprising a first end portion for attachment to the upper portion of a ladder and a second end portion, wherein at least a portion of the arm is flexible; and
a holding mechanism joined to the second end portion of the arm.

2. The safety device of claim 1 wherein at least a portion of said arm is extensible.

3. The safety device of claim 1 wherein at least a portion of said arm is retractable.

4. The safety device of claim 1 comprising at least one additional arm.

5. The safety device of claim 1 wherein said holding mechanism is adjustable.

6. The safety device of claim 5 wherein said holding mechanism comprises a clamp.

7. A ladder comprising a pair of rails supporting a plurality of spaced apart rungs, a lower portion, and an upper portion, and a safety device comprising:
an arm for attaching to the upper portion of a ladder, said arm having two end portions comprising a first end portion for attachment to the upper portion of a ladder and an opposing second end portion; and
a holding mechanism joined to the second end portion of the arm, wherein said holding mechanism to engages a portion of a structure by at least one of the following mechanisms: exerting a force on a portion of the structure, and fastening to a portion of the structure.

8. A method for securing a ladder to a structure, said method comprising:
providing a ladder having an upper portion and a lower portion;
providing a safety device for said ladder, said safety device comprising at least one arm for attaching to an upper portion of a ladder, said arm having two end portions comprising a first end portion for attachment to the upper portion of a ladder and a second end portion, and a holding mechanism joined to the second end portion of the arm;
placing the lower portion of the ladder directly or indirectly on the ground; and
at least temporarily joining the holding mechanism to at least a portion of a structure.
